(19) United States
(12) Patent Application Publication
(10) Pub. No.: US 2005/0048253 A1
(43) Pub. Date: Mar. 3, 2005

(54) Dyed floor covering fabric made with combination of solution dyed and non-solution dyed yarn

(76) Inventors: Thomas D. Nord, Yonezawa-shi (JP); Seiin Kobayashi, Yamagata-ken (JP); Manabu Saito, Yamagata-ken (JP)

Correspondence Address: MILLIKEN & COMPANY, 920 MILLIKEN RD (M-495), PO BOX 1926, SPARTANBURG, SC, 29304, US

(21) Appl. No.: 10/653,484

(22) Filed: Sep. 2, 2003

(51) Int. Cl. B32B 33/00

(52) U.S. Cl. 428/89; 428/97; 428/95; 428/92

(57) ABSTRACT

A floor covering made from a combination of solution dyed yarn and non-solution dyed yarn. The non-solution dyed yarn can first be combined with solution dyed yarn to form a pile fabric. Thereafter, the pile fabric can additionally be dyed or patterned in preparation for possible incorporation into a floor covering product.

### BACKGROUND OF THE INVENTION

The present invention relates generally to dyed fabrics, and, in particular, to dyed fabrics that incorporate solution dyed and non-solution dyed yarns.

Pile fabrics are well-known. These fabrics are manufactured by introducing tufts, loops, or other erect yarns on all or part of the fabric surface. Pile fabrics are commonly used in floor covering or mat products, as well as broadloom carpets and area rug products. “Broadloom” refers to carpets woven in widths from 54 inches to 18 feet, as distinguished from narrow loom widths of 27 to 36 inches.

Typically, mat products and broadloom carpet products, which include pile fabrics, are made with non-solution dyed yarns, because these types of yarns are relatively inexpensive. As used herein, “non-solution dyed yarns” refers to yarns that are not pre-colored by the addition of a pigment or dye to the polymer melt or spinning solution prior to extrusion of the yarn fibers. In other words, non-solution dyed yarns are dyed after the formation of the yarn fibers by various methods such as atmospheric dying.

However, pile fabrics made of non-solution dyed yarns will fade over time with repeated washing. Exposure to light, UV radiation, and inclement weather may also contribute to the fading of the mat and carpet products employing non-solution dyed yarns. Additionally, the color of the mat and carpet products can fade or discolor when chemicals, such as bleach, are spilled on the mats. Finally, soiling and stains can degrade the appearance and value of the mat and carpet products including pile fabrics made with non-solution dyed yarns.

The use of pile fabrics containing only solution-dyed fabrics enhances the retention of color of the mat and carpet products. Because solution-dyed, otherwise referred to as “mass-colored,” fabrics are colored during the formation of yarn fibers, the colors of the fabrics are fast to most destructive agents, such as light, weather, and washing. Unfortunately, these solution-dyed fabrics, as well as the products that incorporate the fabrics, are very expensive.

Accordingly, there remains a need for floor covering products that are made of fabrics that can better retain color without being cost prohibitive.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

According to its major aspects and briefly recited, an embodiment of the present invention is generally a dyed floor covering fabric made from a combination of solution dyed and non-solution dyed yarns that can be incorporated into any number of finished products including, but not limited to, dust control mats, broadloom carpet, or area rugs. The present invention also includes a method for making such a floor covering, fabric or component. In particular, white non-solution dyed yarn can first be combined with solution dyed yarn to form a pile fabric. Thereafter, the pile fabric can additionally be dyed or patterned in preparation for possible incorporation into a floor covering product.

A feature of the present invention is the use of a pile fabric made of a combination of solution dyed and non-solution dyed yarns. The use of non-solution dyed yarns is advantageous, because these yarns are relatively inexpensive, and are readily dyeable with inexpensive printing technologies. However, non-solution dyed yarns alone are inadequate to prevent fading and staining resulting from exposure to such things as washing, weather, UV light, and chemical agents. Therefore, the incorporation of solution-dyed yarn into the pile fabric aids in masking the effects of these destructive agents on the color and quality of the fabric.

Another feature of the present invention is the use of a pile fabric made of a combination of non-solution dyed and solution dyed yarns that can be additionally dyed or patterned. When the fabric is additionally dyed or “overprinted” (patterned), because the solution dyed portion of the overall product will not fade, the fabric itself or any product into which the fabric is incorporated is perceived as lasting longer even though the non-solution dyed overprinted yarn may fade to some degree. Accordingly, the solution dyed yarn helps to “camouflage” the potential fading of the overall product, thereby adding value to the product and enhancing the product's useful life. Consequently, purchasers of these types of products receive more of a return on their investment. Further, those involved in renting out this type of product are able to make more money per product over time, as they can keep the product in circulation longer, or, alternatively, they can secure a higher rental fee.

Other features and advantages of the present invention will be apparent to those skilled in the art from a careful reading of the Detailed Description of the Preferred Embodiments presented below and accompanied by the drawings.

### BRIEF DESCRIPTION OF THE DRAWINGS

In the drawings,

FIG. 1 is a top view of a floor covering according to an embodiment of the present invention;

FIG. 2 is a cross-sectional view of a floor covering according to an embodiment of the present invention;

FIG. 3 is a bottom view of a floor covering according to an embodiment of the present invention;

FIG. 4 is a top view of a floor covering according to a first alternative embodiment of the present invention;

FIG. 5 is a cross-sectional view of a floor covering according to a first alternative embodiment of the present invention;

FIG. 6 is a bottom view of a floor covering according to a first alternative embodiment of the present invention;

FIG. 7 is a top view of a floor covering according to a second alternative embodiment of the present invention;

FIG. 8 is a cross-sectional view of a floor covering according to a second alternative embodiment of the present invention;

FIG. 9 is a bottom view of a floor covering according to a second alternative embodiment of the present invention;

FIG. 10 is a cross-sectional view of a floor covering according to a third alternative embodiment of the present invention;

FIG. 11 is a cross-sectional view of a floor covering according to a fourth alternative embodiment of the present invention;

FIG. 12 is a cross-sectional view of a floor covering according to a fifth alternative embodiment of the present invention;

FIG. 13 is a cross-sectional view of a floor covering according to a sixth alternative embodiment of the present invention;

FIG. 14 is a detailed view of a floor covering according to a seventh alternative embodiment of the present invention;

FIG. 15 is a detailed view of a floor covering according to an eighth embodiment of the present invention.

### DETAILED DESCRIPTION OF THE PREFERRED EMBODIMENTS

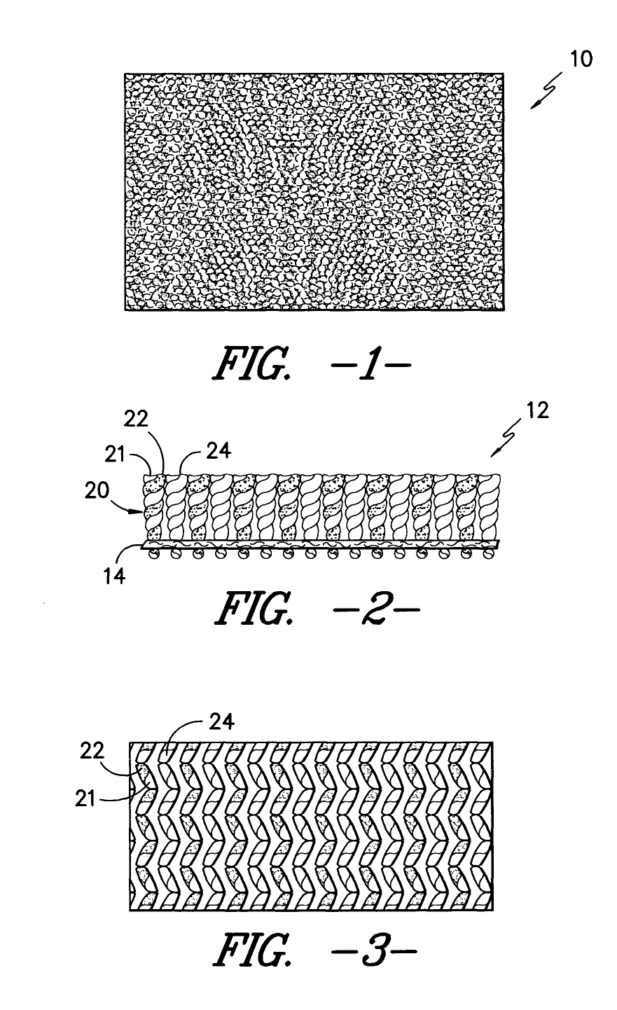

An embodiment of the present invention is a dyed floor covering 10 that is made of a pile fabric 12. “Pile” is a fabric effect formed by introducing tufts, loops, or other erect yarns on all or part of the fabric surface. As illustrated in FIGS. 1-6, the pile fabric 12 is made of a combination of two types of yarn. Specifically, the pile fabric 12 is formed from solution dyed yarn and non-solution dyed yarn. Otherwise referred to as “mass-colored” yarn, solution dyed yarn is a manufactured yarn that has been colored by the introduction of pigments or insoluble dyes into the polymer melt or spinning solution prior to extrusion whereby fibers are formed. Accordingly, non-solution dyed yarn is a yarn that has been colored by any other method than by introducing pigments during the extrusion of the yarn. For example, non-solution dyed yarn may be colored by atmospheric dyeing, batik, chain dyeing, cross dyeing, high-temperature dyeing, ingrain, jet dyeing, muff dyeing, pad dyeing, piece dyeing, printing, reserve dyeing, short-liquor dyeing, skein dyeing, solution dyeing, solvent dyeing, stock dyeing, thermal fixation, union dyeing, yarn dyeing, space dyeing, pressure dyeing, and any combination thereof, or the yarn may be natural in color. The non-solution dyed yarn is preferably nylon 6,6, but may be made from any natural or synthetic yarn including, but not limited to nylon, polyester, acrylic, polypropylene, rayon, cotton, wool, or any combination thereof.

Depending on the particular end use of the floor covering 10, the non-solution dyed yarn and the solution dyed yarn can be combined in a variety of alternative embodiments. In a first embodiment, as shown in FIGS. 1-3, the pile fabric 12 includes a configuration in which one ply of solution dyed yarn 22 and one ply of non-solution dyed yarn 21 are combined to form a multi-ply yarn. As illustrated, the pile fabric 12 includes one end of the multi-ply yarn 20 that is alternated with one end of the non-solution dyed yarn 24. As used herein, “ply” refers a single yarn that is included in a plied yarn wherein a number of single yarns have been twisted together. An “end” of yarn refers to a single division of yarn along the either the warp or weft direction of a fabric. Therefore, one end of a fabric can include a multi-ply yarn. Although the multi-ply yarn illustrated includes one ply of solution dyed yarn 22 that is twisted with one ply of non-solution dyed yarn 21 to form a two-ply yarn, it is contemplated that alternative combinations of plies can be employed. For example, two ends of non-solution dyed yarn 21 can be plied with one end of solution dyed yarn 22 to for a three-ply yarn. Additionally, two plies of non-solution dyed yarn 21 can be plied with two ends of solution dyed yarn 22 to form a four-ply yarn. Preferably, the resulting multi-ply yarn contains a ratio of about 1:3 to about 1:2 of solution dyed yarn to non-solution dyed yarn.

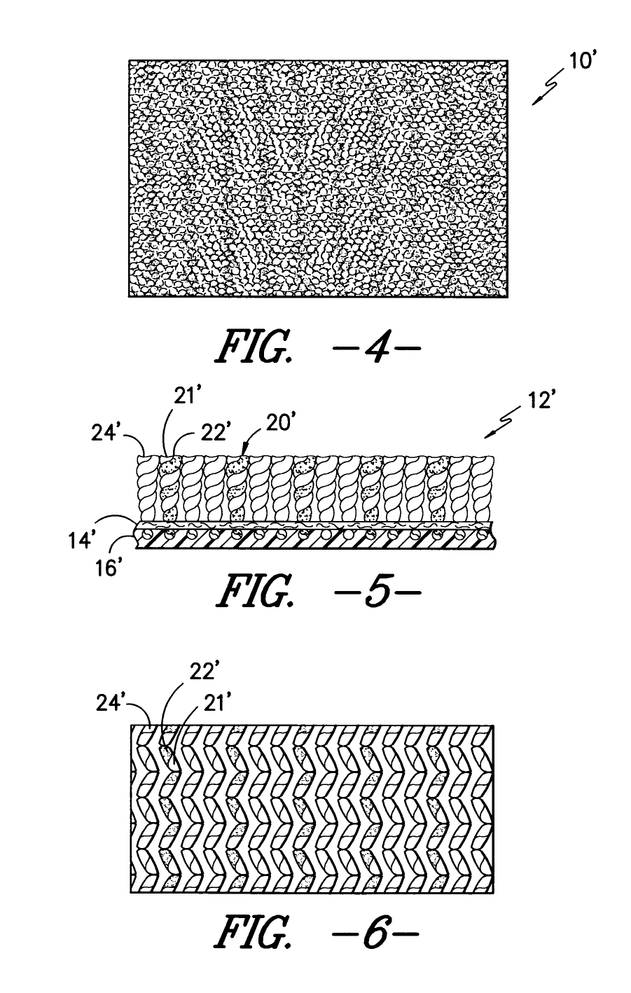

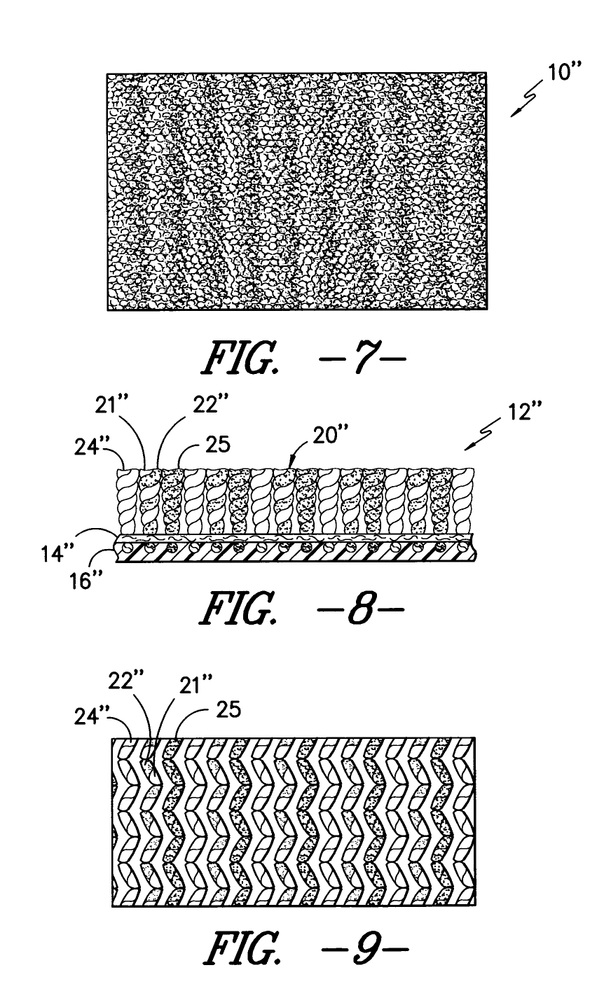

In a second alternative embodiment, as shown in FIGS. 4-6, the pile fabric 12′ includes a configuration in which two ends of non-solution dyed yarn 24′ alternating with one end of multi-ply yarn 20′. In a third alternative embodiment shown in FIGS. 7-9, one end of non-solution dyed yarn 24″ is alternated with one end of multi-ply yarn 20″ and with one end of solution dyed yarn 25. Accordingly, there exist a number of configurations and embodiments that may be employed depending on the desired coloration and the intended use of the floor covering 10 that should not be limited by these described examples.

Although a wide variety of materials may be used to in the formation of the solution dyed yarn, including, but not limited to, nylon, polypropylene, polyester, acrylic, and glass, the solution dyed yarn is preferably formed from nylon 6,6. Further, the solution dyed yarn may be either dyeable (non-sulfonated) or non-dyeable (sulfonated). Although a darker shade of solution dyed yarn is preferable in the present invention, any color yarn may be used.

The non-solution dyed yarn may be made from a variety of both natural or synthetic material, such as, but not limited to, nylon, polypropylene, polyester, cotton, wool, acrylic, glass, rayon or a combination thereof. Preferably, the non-solution dyed yarn is preferably formed from nylon 6,6. Preferably, the non-solution dyed yarn is atmospherically dyed, although other methods of dyeing are contemplated by the present invention such as those previously described. As used herein, “atmospherically dyed” refers to yarn that has been dyed by means in which the dye is fixed at ambient atmospheric pressure. As further used herein, “fixed” refers to setting a dye after dyeing or printing, usually by steaming or other heat treatment. Dyes can also be fixed by chemical reaction alone, as well as by using an RF (radio frequency) oven.

The thickness of the non-solution dyed yarn and the solution dyed yarn can also vary depending on the particular end use of the floor covering 10. The thickness can be varied through the use of monofilament yarns and multifilament yarns in the pile fabric 12 of the present invention. In the case that fine fibers are desirable, multifilament yarns can be employed having a range of thickness from about 0.1 to about 100 dpf (denier per filament) and, preferably, from about 1 to about 50 dpf. In the case that heavy or more coarse fibers are used in the invention, monofilament yarns can be employed having a range of thickness of about 100 to about 5000 dpf, and, preferably, about 100 to about 2000 dpf.

Preferably, the pile fabric 12 of the present invention includes a backing layer 14. Most preferably, the backing layer 14 is a nylon-coated non-woven polyester. However, other backing materials can be employed, including any woven or non-woven material such as, but not limited to nylon, polypropylene, polyester, cotton, wool, acrylic, glass, acrylate and polyamide binders, latex, rubber, or a combination thereof. The yarn may be placed into the backing layer 14 as through tufting or needle punching or it may be bonded or laminated to the bottom of the pile fabric 12.

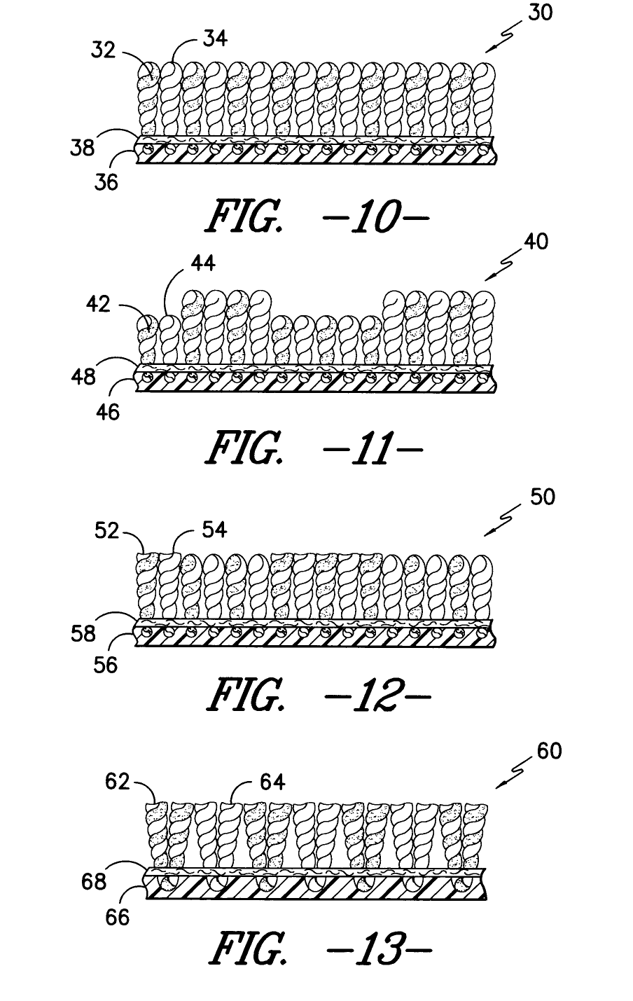

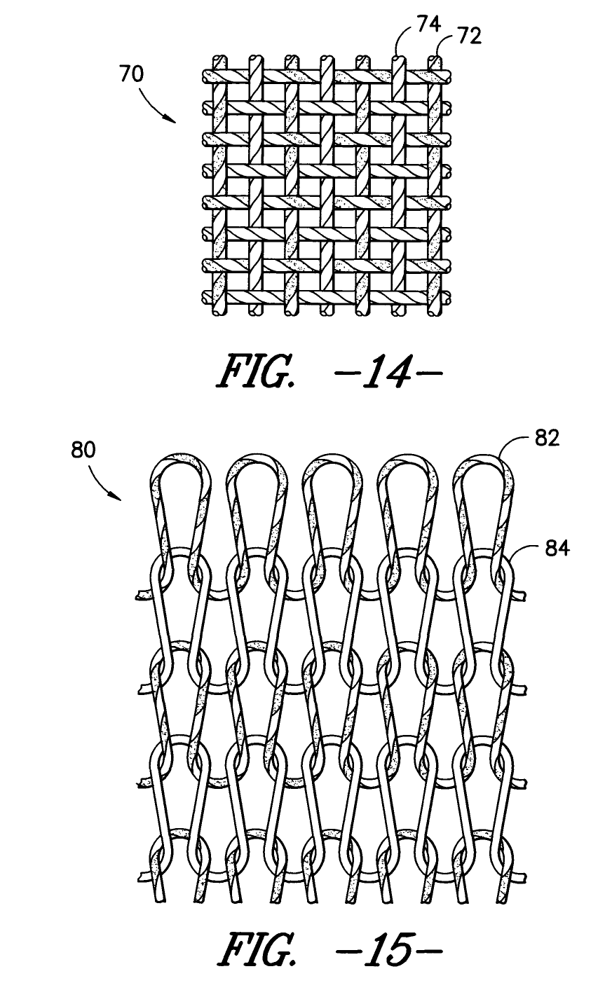

As illustrated in FIGS. 10-15, the pile fabric 30, 40, 50, 60, 70, 80 can be formed by various methods, including by tufting as a cut pile (FIGS. 2, 5 and 8), by tufting as a loop pile (FIG. 10), by tufting as a multi-level pile (FIG. 11), by tufting as a combination loop and cut pile (FIG. 12), by needle punching (FIG. 13), by weaving (FIG. 14), or by knitting (FIG. 15). Alternatively, the pile fabric 30, 40, 50, 60, 70, 80 can also be made by any combination of these listed methods. Although FIGS. 10-15 show the pile fabric 30, 40, 50, 60, 70, 80 as having a configuration in which one end of multi-ply yarn 32, 42, 52, 62, 72, 82 is alternated with one end of non-solution dyed yarn 34, 44, 54, 64, 74, 84, any configuration such as those described and suggested above can be employed. After the solution dyed yarn, the non-solution dyed yarn and the backing layer 14, 14′, 14″, 38, 48, 58, 68 have been combined to form the pile fabric 12, 12′, 12″, 30, 40, 50, 60, 70, 80, the fabric may be reinforced by one or more additional or secondary backing layers 16′, 16″, 36, 46, 56, 66. The pile fabric 12, 12′, 12″, 30, 40, 50, 60, 70, 80 may be additionally dyed or overprinted before or after the combination with the secondary backing layer(s). The secondary backing layers may be made from any suitable material, including but not limited to rubber, latex, urethane, polypropylene, polyethylene, nylon, polyester, acrylonitrile-butadiene-styrene, PVC, other thermoplastic elastomers or thermoset plastics, and any combination thereof. Further, a scrim material (not shown) may be used within the secondary backing layers for additional reinforcement and dimensional stability. For broadloom carpets, one preferred embodiment is to combine the pile fabric 12, 12′, 12″, 30, 40, 50, 60, 70, 80 with a secondary backing of latex or urethane and scrim. This broadloom embodiment may also be cut into various shapes to form area rugs, either with or without edge finishing, which may include surge yarn or tape around the edges thereof.

As used herein, “overprinted” refers to yarn that has been dyed at least an additional time following the initial dyeing of the yarn. This additional dyeing may be performed by various methods including, but is not limited to dye injection, screen-printing, pad dyeing, flocking, or combination thereof. Further, the floor covering 10 (FIG. 1) may be either patterned or a solid color as a result of the additional dyeing.

As previously discussed, a feature of the present invention is the use of the pile fabric 12 made of a combination of solution dyed yarn and non-solution dyed yarn. The use of non-solution dyed yarn is advantageous, because these yarns are relatively inexpensive, and are readily dyeable with inexpensive technologies. For example, non-solution dyed yarn can be dyed using the technology described in U.S. Pat. No. 4,808,191, which is incorporated herein by reference. However, non-solution dyed yarn tends to fade when washed repeatedly or when exposed to such agents as UV light and certain chemicals. Furthermore, non-solution dyed yarn is not effective in masking stains, such as those caused by soil.

Solution dyed yarn, on the other hand, is more light fast, washfast, resistant to weathering, and resistant to change in color due to chemical exposure when compared to non-solution dyed yarn. However, solution dyed yarn is typically very expensive as compared to other yarns. Therefore, by combining the non-solution dyed yarn with solution dyed yarn, the present invention achieves a pile fabric 12 that is both able to effectively withstand fading and staining, and that is economical.

Another feature of the present invention is the use of pile fabric 12 made of a combination of non-solution dyed yarn and solution dyed yarn that can be additionally dyed or patterned. When the pile fabric 12 is additionally dyed or overprinted (patterned) to make the fabric covering 10 product, because the solution dyed yarn portion of the overall product will not fade, the fabric product itself or any other product into which the fabric is incorporated is perceived as lasting longer even though the non-solution dyed overprinted yarn may fade to some degree. The potential fading of the pile fabric 12 is further enhanced by the use of multi-ply yarn made of solution dyed yarn and non-solution dyed yarn. As described, the preferred ratio of solution dyed yarn to non-solution dyed yarn can be about 1:3 to about 1:2 in the multi-ply yarn. Accordingly, the solution dyed yarn helps to “camouflage” the potential fading of the overall product, thereby adding value to the product and enhancing the product's useful life. Consequently, purchasers of these types of products receive more of a return on their investment. Further, those involved in renting out this type of product are able to make more money per product over time, as they can keep the product in circulation longer, or, alternatively, they can secure a higher rental fee.

The floor covering 10 described above was tested against traditional floor coverings that were made with only non-solution dyed yarn. Both the traditional floor coverings and the floor covering 10 of the present invention were laundered. Thereafter, the floor coverings were inspected for any adverse effects from the washing. The overall perceived fading of the floor covering 10 of the present invention was improved when compared to the traditional mats.

Finally, there are many alternative embodiments and modifications of the present invention that are intended to be included within the spirit and scope of the following claims.

1. A fabric, comprising:
solution dyed yarn; and
non-solution dyed yarn, wherein said solution dyed yarn and said non-solution dyed yarn are combined to form a pile fabric; and wherein said pile fabric is overprinted.

2. The fabric as recited in claim 1, wherein said pile fabric is reinforced by a backing layer.

3. The fabric as recited in claim 2, wherein said backing layer is selected from the group consisting of woven or non-woven material, nylon, polypropylene, polyester, cotton, wool, acrylic, glass, acrylate and polyamide binders, latex, rubber, and combination thereof.

4. The fabric as recited in claim 1, wherein said non-solution dyed yarn is dyed by a method selected from the group consisting of atmospheric dyeing, batik, chain dyeing, cross dyeing, high-temperature dyeing, ingrain, jet dyeing, muff dyeing, pad dyeing, piece dyeing, printing, reserve dyeing, short-liquor dyeing, skein dyeing, solution dyeing, solvent dyeing, stock dyeing, thermal fixation, union dyeing, yarn dyeing, space dyeing, pressure dyeing, and any combination thereof.

5. The fabric as recited in claim 1, wherein one ply of said non-solution dyed yarn is combined with one ply of said solution dyed yarn to form a multi-ply yarn.

6. The fabric as recited in claim 5, wherein said pile fabric includes one end of said non-solution dyed yarn alternating with one end of said multi-ply yarn.

7. The fabric as recited in claim 5, wherein said pile fabric includes two ends of said non-solution dyed yarn alternating with one end of said multi-ply yarn.

8. The fabric as recited in claim 5, wherein said pile fabric includes one end of said non-solution dyed yarn alternating with one end of said multi-ply yarn and one end of said solution dyed yarn.

9. The fabric as recited in claim 5, wherein said multi-ply yarn includes a ratio of said non-solution dyed yarn to said solution dyed yarn of about 1:3.

10. The fabric as recited in claim 5, wherein said multi-ply yarn includes a ratio of said non-solution dyed yarn to said solution dyed yarn of about 1:2.

11. The fabric as recited in claim 1, wherein said pile fabric is formed by a method that is selected from the group consisting of cut pile tufting, loop pile tufting, multi-level pile tufting, combination loop and cut pile tufting, needle punching, weaving, knitting, and any combination thereof.

12. The fabric as recited in claim 1, wherein said solution dyed yarn and said non-solution dyed yarn have a thickness ranging from about 0.1 dpf to about 5000 dpf.

13. The fabric as recited in claim 1, wherein said solution dyed yarn is dyeable.

14. The fabric as recited in claim 1, wherein said solution dyed yarn is made from a material selected from the group consisting of nylon, polypropylene, polyester, acrylic, glass, and any combination thereof.

15. The fabric as recited in claim 1, wherein said pile fabric is patterned.

16. The fabric as recited in claim 1, wherein said pile fabric is a solid color.

17. The fabric as recited in claim 2, further including a secondary backing layer.

18. The fabric as recited in claim 17, wherein said secondary backing layer is made from material selected from the group consisting of rubber, latex, urethane, polypropylene, polyethylene, nylon, polyester, acrylonitrile-butadiene-styrene, PVC and any combination thereof.

19. The fabric as recited in claim 17, wherein said secondary backing layer also includes a scrim.

20. The fabric as recited in claim 1, wherein said non-solution dyed yarn is made from material selected from the group consisting of nylon, polyester, acrylic, polypropylene, rayon, cotton, glass, wool, and any combination thereof.

21. A fabric, comprising:
a pile fabric, wherein a portion of said pile fabric is made of solution dyed yarn and non-solution dyed yarn, and wherein said solution dyed yarn and said non-solution dyed yarn are twisted together to form a multi-ply yarn.

22. The fabric as recited in claim 21, wherein said pile fabric is overprinted.

23. A method for making a fabric, comprising:
providing a multi-ply yarn;
providing a non-solution dyed yarn;
combining said multi-ply yarn with said non-solution dyed yarn to form a pile fabric;
dyeing said pile fabric.

24. The method as recited in claim 23, further comprising reinforcing said pile fabric with a backing layer.

25. A fabric made by the process comprising:
providing a multi-ply yarn;
providing a non-solution dyed yarn;
combining said multi-ply yarn with said non-solution dyed yarn to form a pile fabric;
dyeing said pile fabric.
reinforcing said pile fabric with a backing layer.
